(19) United States
(12) Patent Application Publication
(10) Pub. No.: US 2016/0129888 A1
(43) Pub. Date: May 12, 2016

(54) SYSTEM FOR CONTROLLING SPRAYING OF WASHER FLUID OF WIPER BLADE

(71) Applicant: HYUNDAI MOTOR COMPANY, Seoul (KR)

(72) Inventors: Hyun Sub KIM, Seoul (KR); Young Sub OH, Suwon-si (KR); Jin Hee LEE, Seoul (KR); Nak Kyoung KONG, Seongnam-si (KR)

(21) Appl. No.: 14/872,093

(22) Filed: Sep. 30, 2015

(30) Foreign Application Priority Data
Nov. 7, 2014 (KR) 10-2014-0154161

(51) Int. Cl. B60S 1/48; B60S 1/08

(52) U.S. Cl. CPC B60S 1/482; B60S 1/08

(57) ABSTRACT

A system for controlling spraying of washer fluid from a washer nozzle-integrated wiper blade having a wiper motor supplying a driving force for wiping of the wiper blade includes a position sensing plate disposed in the wiper motor and configured to rotate with an output shaft of the wiper motor when the wipe motor operates. The position sensing plate has a plurality of alternating closed periods and open periods. A contact pin is configured to physically come in contact with the position sensing plate in the closed periods and separate from the position sensing plate in the open periods when the wiper motor operates, and transmit signals a indicating whether it comes in contact with or separates from the position sensing plate. A controller controls operation of the wiper motor on the basis of the signals transmitted by the contact pin.

### CROSS-REFERENCE TO RELATED APPLICATION

This application claims under 35 U.S.C. §119(a) the benefit of Korean Patent Application No. 10-2014-0154161 filed on Nov. 7, 2014, the entire contents of which are incorporated herein by reference.

### TECHNICAL FIELD

The present disclosure relates to a system for controlling spraying of washer fluid from a washer nozzle-integrated wiper blade. More particularly, it relates to a system for controlling spraying of washer fluid from a washer nozzle-integrated wiper blade which optimally controls spraying of washer fluid from a washer nozzle by controlling the spraying timing of the washer fluid on the basis of the movement direction and the exact position of a washer nozzle-integrated wiper blade.

### BACKGROUND

In general, vehicles are equipped with wipers for removing rain, snow, and other dirt on the windshield glass and the rear window glass.

A wiper, which is a piece of equipment for cleaning glass using a wiper blade turned by a wiper motor, is designed such that a rotational motion generated by a wiper motor is transmitted to a wiper arm through a wiper linkage system and a wiper blade cleans a windshield glass while reciprocating in a predetermined area by the wiper arm, thereby keeping the driver's visual field.

Recently, wipers make more convenient and safe movements with addition of various electronic control systems or sensors and several switches.

Washer nozzles for spraying washer fluid supplied from a tank keeping the washer fluid to a windshield glass are integrated with a wiper blade so that dirt can be more easily removed when a wiper cleans the windshield glass.

Those washer nozzles are controlled by a controller (for example, a BCM (Body Control Module)) in a vehicle and the controller controls the operation of washer nozzles on the basis of electrical signals from a wiper motor.

Referring to FIG. 5 illustrating a wiper motor, when a copper plate 3 on a motor gear unit 1 (fitted on an output shaft of the wiper motor and rotated by the wiper motor) physically comes in contact with separates from a contact pin (connecting pin) of a parking switch, a controller can recognize the rotational periods of the motor gear unit 1 and the copper plate 3 from a signal from the parking switch and can calculate the time that the motor gear unit 1 and the copper plate 3 take to rotate one time on the basis of a non-contact period N of the copper plate 3 where the copper plate 3 is not in contact with the contact pin of the parking switch while the motor gear unit 1 rotates.

The controller recognizes a signal showing the non-contact period N of the copper plate 3 by estimating the position of a wiper blade on the basis of the time that the copper plate 3 takes to rotate one time, and then washer fluid is sprayed in predetermined time t1 and t2 (see FIG. 1). For example, when the copper plate 3 takes one second to rotate one time, the controller operates a washer nozzle in 200 ms from when it recognizes a non-contact period N of the copper plate 3, thereby spraying washer fluid.

However, when spraying washer fluid is controlled on the basis of an estimated position of a wiper blade, as described above, the washer fluid may be sprayed at a wrong time due to external environmental conditions such as the frictional condition of a windshield glass or interference by an external force, and it is difficult to cope with a change in restriction status of a wiper blade and a change in operation speed of a wiper motor.

The above information disclosed in this Background section is only for enhancement of understanding of the background of embodiments of the invention and therefore it may contain information that does not form the prior art that is already known in this country to a person of ordinary skill in the art.

### SUMMARY

The present disclosure has been made in an effort to solve the above-described problems associated with prior art and to provide a system for controlling spraying of washer fluid from a washer nozzle-integrated wiper blade which optimally controls spraying of washer fluid by controlling the spraying time of washer fluid on the basis of the movement direction and the exact position of the washer nozzle-integrated wiper blade.

In one aspect, the present disclosure provides a system for controlling spraying of washer fluid from a washer nozzle-integrated wiper blade having a wiper motor supplying a driving force for wiping of the wiper blade. The system includes a position sensing plate disposed in the wiper motor and configured to rotate with an output shaft of the wiper motor when the wipe motor operates. The position sensing plate has a plurality of alternating closed periods and open periods. A contact pin is configured to physically come in contact with the position sensing plate in the closed periods and separate from the position sensing plate in the open periods, when the wiper motor operates, and transmit signals indicating whether it comes in contact with or separates from the position sensing plate. A controller controls operation of the wiper motor on the basis of the signals transmitted by the contact pin.

In an embodiment, the controller may operate the washer motor to start spraying of washer fluid when the contact pin separates from the position sensing plate and to stop spraying of the washer fluid, when the contact pin comes in contact with the position sensing plate.

In certain embodiments, the position sensing plate may have a first closed period and a second closed period with open periods therebetween, and the controller may operate the washer motor to start spraying washer fluid when the contact pin starts to separate from the first closed period of the position sensing plate after being in contact with the first closed period, and the controller may control the washer motor to stop spraying of the washer fluid, when the contact pin comes in contact with the second closed period of the position sensing plate.

In another embodiment, the controller may operate the washer motor to start spraying of washer fluid when the contact pin separates from the position sensing plate and to stop spraying the washer fluid when a predetermined time passes after the washer fluid starts to be sprayed.

In certain embodiments, the position sensing plate may have a first closed period and a second closed period with open periods therebetween, and the controller may operate the washer motor to start spraying washer fluid when the contact pin starts to separate from the first closed period of the position sensing plate after being in contact with the first closed period, and the controller may control the washer motor to stop spraying of the washer fluid when a predetermined time passes after the washer fluid starts to be sprayed. In certain embodiments, the predetermined time may be 100 ms.

In certain embodiments, the position sensing plate may include at least one copper plate.

In certain embodiments, the controller may operate the washer motor to start spraying of washer fluid when the contact pin comes in contact with the position sensing plate and to stop spraying of the washer fluid when the contact pin separates from the position sensing plate.

According to certain embodiments of the system for controlling spraying of washer fluid from a washer nozzle-integrated wiper blade, since a wiper blade rotates upon spraying washer fluid and the washer fluid is sprayed in the movement direction of the wiper blade, the visual field of a driver is not influenced by rain and most of washer fluid is sprayed into the area to be wiped, so unnecessary consumption of washer fluid is minimized.

Other aspects and embodiments of the invention are discussed infra. It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of embodiments of the present invention are discussed infra.

### BRIEF DESCRIPTION OF THE DRAWINGS

The above and other features of embodiments of the present invention will now be described in detail with reference to certain exemplary embodiments thereof illustrated in the accompanying drawings which are given hereinbelow by way of illustration only, and thus are not limitative of the present invention, and wherein:

FIG. 1 is a schematic diagram illustrating a system for controlling spraying of washer fluid from a washer nozzle-integrated wiper blade according to an embodiment of the present invention;

FIG. 2 is a diagram illustrating a way of controlling spraying of washer fluid from a washer nozzle-integrated wiper blade according to embodiments of the present invention;

FIG. 3 is a diagram illustrating a way of controlling spraying of washer fluid from a washer nozzle-integrated wiper blade according to embodiments of the present invention while the wiper blade is moving upwards; and

FIG. 4 is a diagram illustrating a way of controlling spraying of washer fluid from a washer nozzle-integrated wiper blade according to embodiments of the present invention while the wiper blade is moving downwards.

FIG. 5 is a diagram illustrating a way of controlling spraying of washer fluid in the related art.

controller It should be understood that the appended drawings are not necessarily to scale, presenting a somewhat simplified representation of various preferred features illustrative of the basic principles of the invention. The specific design features of embodiments of the present invention as disclosed herein, including, for example, specific dimensions, orientations, locations, and shapes will be determined in part by the particular intended application and use environment.

In the Figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While exemplary embodiments of the invention will be described, it will be understood that present description is not intended to limit the invention to those exemplary embodiments. On the contrary, the invention includes not only the exemplary embodiments, but also various alternatives, modifications, equivalents and other embodiments, which may be included within the spirit and scope of the invention as defined by the appended claims.

Hereinafter, embodiments of the present invention will be described for those skilled in the art to easily achieve it.

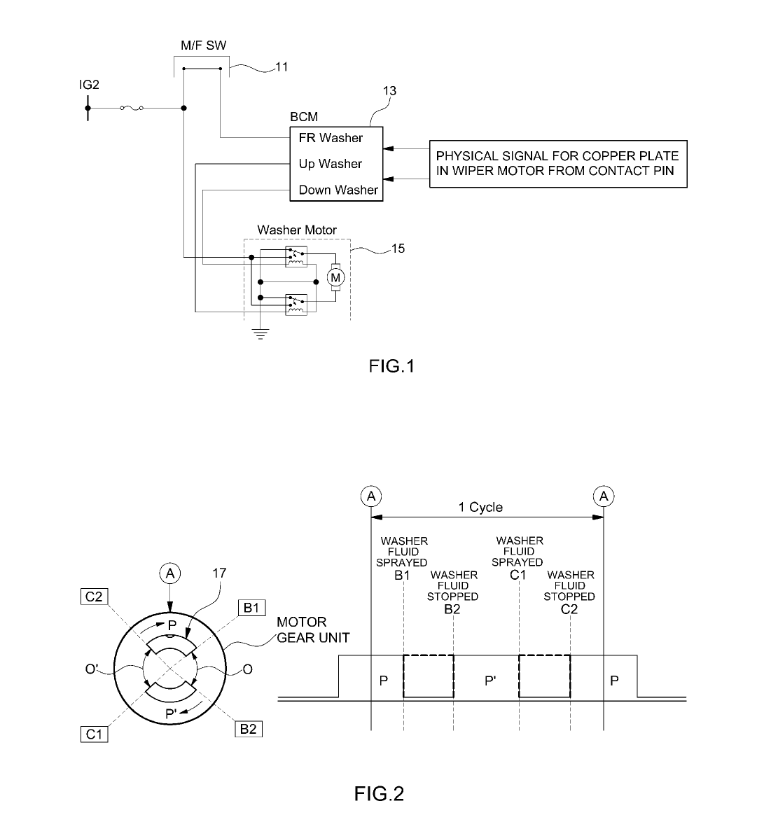

FIG. 1, a schematic circuit diagram illustrating a system for controlling spraying of washer fluid from a washer nozzle-integrated wiper blade, illustrates a control relationship between a controller 13, for example, a BCM (Body Control Module) and a washer motor 15 when a physical contact signal (contact or separation) of a position sensing plate in the wiper motor 15 is inputted.

When a user operates a multifunction switch (11 in FIG. 1), power is supplied to a wiper motor and a wiper blade is operated to clean glass. The powered wiper motor generates torque and a motor gear unit (for example, wheel gear) on an output shaft of the wiper motor is rotated by the torque. A position sensing plate is integrally formed with the motor gear unit and rotated with the motor gear unit.

A contact pin, which can transmit electrical signals to a controller in a vehicle by physically coming in contact with or separating from the position sensing plate in the wiper motor, is mechanically and physically connected to the position sensing plate. In certain embodiments the contact pin is a contact pin of a parking switch.

The position sensing plate is a plate with at least one predetermined opening portion, so it comes in contact with and separates from the contact pin fixed at at least one predetermined position while being rotated by the torque from the wiper motor.

That is, the contact pin is fixed to a side of the position sensing plate, so that as the position sensing plate is rotated, physical contact and separation are generated between the contact pin and the position sensing plate.

In embodiments of the present invention, in order to optimally control spraying of washer fluid by a controller in a vehicle when physical contact signals (signals generated by contact/separation with/from a contact pin) of a position sensing plate in a wiper motor, the exact movement direction and position of a wiper blade operated by the wiper motor may be found by improving the shape of a position sensing plate, such that the timing of turning on/off a washer motor (washer nozzle) is exactly controlled so that spraying of washer fluid can be optimally controlled.

FIG. 2 illustrates a the position sensing plate 17 in a wiper motor according to an embodiment of the present invention and the waveform of a signal input to a controller by rotation of the position sensing plate 17. In certain embodiments, the position sensing plate 17 may include one or more copper plates. In certain embodiments, the position sensing plate 17 may have portions that contain copper plate and portions that do not contain copper plate. In certain embodiments, position sensing plate 17, the portions containing copper plate may alternate with the portions that do not contain the copper plate.

As illustrated at the left side in FIG. 2, a position sensing plate 17 in a wiper motor has a plurality of closed periods P and P′ and open periods O and O′ and is rotated by torque from a wiper motor, when the wiper motor is operated, so it physically comes in contact and separates from a contact pin (not illustrated). In certain embodiments, the contact pin may be in contact with the position sensing plate 17 in closed periods P and P′ and may be separate from the position sensing plate 17 in open periods O and O′. In certain embodiments, the closed periods P and P′ may include copper plate and open periods O and O′ may not include copper plate.

Referring to FIG. 2, the position sensing plate 17 has a first closed period P, a first open period O, a second closed period P′, and a second open period O′ that sequentially connected, and generates pulse signals in response to physical contact/separation with/from the contact pin while being operated by the wiper motor.

In certain embodiments, the position sensing plate 17 has at least two closed periods P and P′ and open periods O and O′, so when it is rotated by torque from the wiper motor, it repeats coming in contact with and separating from the contact pin. Accordingly, an electric signal transmitted to the controller 13 through the contact pin can generate a continuous pulse waveform such as the graph at the right side in FIG. 2.

The first and second open periods O and O′ are open periods of the position sensing plate 17 that, in certain embodiments, is a circular copper plate (that is, the periods without the copper plate), while the first closed period P and the second closed period P′ are closed periods adjacent to the first open period O and the second open period O′ (that is, the periods with the copper plate).

Although not illustrated in the drawings, the contact pin is designed to be able to transmit electrical signals to the controller 13, when it physically comes in contact with or separates from the position sensing plate 17, that is, it transmits signals, which allows for discrimination between the cases when it physically comes in contact with the position sensing plate 17 (closed periods) and when it physically separates from the positions sensing plate 17 (open periods).

For example, the contact pin can come in contact with and separate from the position sensing plate 17 at the position A in FIG. 2 by rotation of the position sensing plate 17.

As can be seen from the right side in FIG. 2, the controller 13 controls turning on (spraying)/off (stopping) of a washer motor (washer nozzle) by discriminating signals when the position sensing plate 17 and the contact pin start to come in contact with each other (B2 and C2) and when the positions sensing plate 17 and the contact pin start to separate from each other (B1 and C1). Further, in certain embodiments, the controller 13 may control the spraying direction of the washer nozzle into up-spraying and down-spraying (or upward movement and downward movement of the wiper blade) by discriminating the first closed period P and the second closed period P′.

In order to discriminate the first closed section P and the second closed section P′, the controller 13 sets in advance the closed period with which the contact pin first comes in contact during one cycle (one round of the wiper motor) as any one of the first closed period P and the second closed period P′.

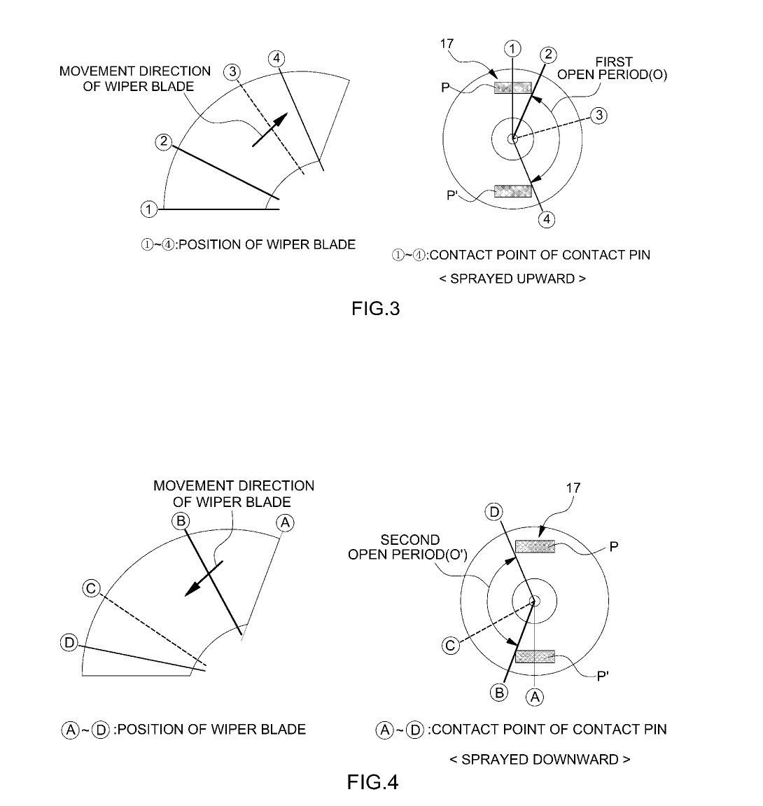

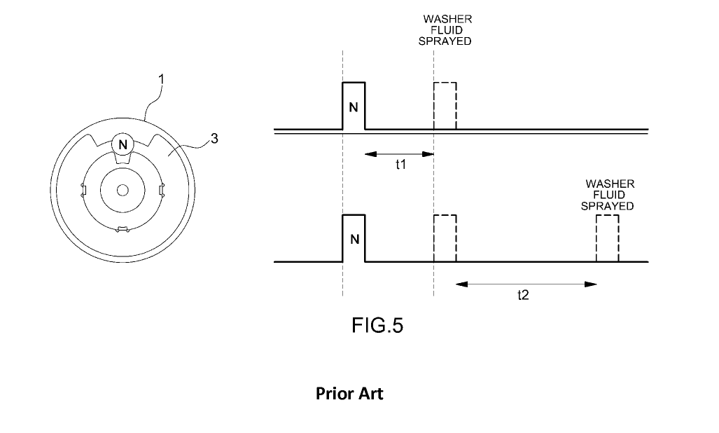

FIGS. 3 and 4, which are provided to illustrate a way of controlling spraying of a washer nozzle (operation of a washer motor) according to embodiments of the present invention, illustrate the relationship between the movement position of the wiper blade operated by a wiper motor and the contact position of the contact pin operated by the rotation of the position sensing plate 17 in the wiper motor.

Referring to FIG. 3 first, the wiper blade is positioned at the lower end of a windshield glass, at the start point of one cycle for one cycle of a wiper motor (see A in FIG. 2), and is moved to the upper end of the windshield glass by the wiper motor, in which a washer motor 15 is operated in response to a signal from the controller 13 and a washer nozzle sprays washer fluid upward.

The controller 13 recognizes that the wiper blade is positioned at the lower end of the windshield glass on the basis of a signal inputted from the contact pin when the wiper blade is at the position \textcircled{1}.

In this process, the contact pin is positioned at the first closed period P (or the second closed period P′) of the position sensing plate 17 and inputs a signal (contact signal) generated by physically coming in contact with the position sensing plate 17 to the controller, and the controller 13 recognizes that the wiper blade is at the lower end of the windshield glass on the basis of the contact signal.

When the wiper blade moves toward the upper end of the windshield glass from the lower end, that is, the position \textcircled{1} and then reaches the position \textcircled{2} and the contact pin starts to physically separate from the position sensing plate 17, coming out of the first closed period P, the controller 13 recognizes the position (close to the lower end of the glass) of the wiper blade on the basis of a signal from the contact pin at the position \textcircled{2} of the position sensing plate 17 and turns on (operates) the washer motor 15, thereby spraying washer fluid.

When the wiper blade keeps moving toward the upper end of the windshield glass and reaches the position \textcircled{4} through the position \textcircled{3} and the contact pin reaches the second closed period P′ after the first open period O and starts to come in contact again with the position sensing plate 17, the controller 13 recognizes the position (close to the upper end of the glass) of the wiper blade on the basis of a signal from the contact pin at the position \textcircled{4} of the position sensing plate 17 and turns off (stops) the washer motor 15, thereby stopping spraying of the washer fluid.

Thereafter, the wiper blade moves up to the upper end (see the position A in FIG. 4) of the windshield glass, without the washer fluid sprayed, and then moves back towards the lower end from the upper end of the windshield glass.

Referring to FIG. 4, the wiper blade down to the position B from the upper end, that is, the position A of the windshield glass and the washer motor 15 operates in response to a signal from the controller, and accordingly, the washer nozzle sprays washer fluid downward.

The controller 13 recognizes that the wiper blade is positioned at the upper end of the windshield glass on the basis of a signal inputted from the contact pin when the wiper blade is at the position A.

In this process, the contact pin is positioned at the second closed period P′ (or the first closed period P) of the position sensing plate 17 and inputs a signal (contact signal) generated by physically coming in contact with the position sensing plate 17, and the controller 13 recognizes that the wiper blade is at the upper end of the windshield glass on the basis of the contact signal.

When the wiper blade moves toward the down end of the windshield glass from the upper end, that is, the position A and then reaches the position B and the contact pin starts to physically separate from the position sensing plate 17, coming out of the second closed period P′, the controller 13 recognizes the position (close to the upper end of the glass) of the wiper blade on the basis of a signal from the contact pin at the position B of the position sensing plate 17 and turns on (operates) the washer motor 15, thereby spraying washer fluid.

When the wiper blade keeps moving toward the lower end of the windshield glass and reaches the position D through the position C and the contact pin reaches the first closed period P after the second open period O′ and starts to come in contact with the position sensing plate 17, the controller 13 recognizes the position (close to the lower end of the glass) of the wiper blade on the basis of a signal from the contact pin at the position D of the position sensing plate 17 and turns off (stops) the washer motor 15, thereby stopping spraying of the washer fluid.

Thereafter, the wiper blade moves to the lower end (position \textcircled{1} in FIG. 3) of the windshield glass, without washer fluid sprayed, and it repeats this process until the wiper motor stops.

Hereafter, another way of controlling spraying of washer fluid is described with reference to FIGS. 3 and 4.

Referring to FIG. 3 first, the wiper blade is positioned at the lower end of a windshield glass, at the start point of one cycle for one cycle of a wiper motor (see A in FIG. 2), and is moved towards the upper end of the windshield glass by the wiper motor, in which a washer motor 15 is operated in response to a signal from the controller 13 and a washer nozzle sprays washer fluid upward.

The controller 13 recognizes that the wiper blade is positioned at the lower end of the windshield glass on the basis of a signal inputted from the contact pin when the wiper blade is at the position \textcircled{1}.

In this process, the contact pin is positioned at the first closed period P (or the second closed period P′) of the position sensing plate 17 and inputs a signal (contact signal) generated by physically coming in contact with the position sensing plate 17 to the controller, and the controller 13 recognizes that the wiper blade is at the lower end of the windshield glass on the basis of the contact signal.

When the wiper blade moves toward the upper end of the windshield glass from the lower end, that is, the position \textcircled{1} and then reaches the position \textcircled{2} and the contact pin starts to physically separate from the position sensing plate 17, coming out of the first closed period P, the controller 13 recognizes the position (close to the lower end of the glass) of the wiper blade on the basis of a signal from the contact pin at the position \textcircled{2} of the position sensing plate 17 and turns on (operates) the washer motor 15, thereby spraying washer fluid. The wiper blade keeps moving toward the upper end of the windshield glass, and the controller 13 turns off (stops) the washer motor in a predetermined time (set in advance) after the contact pin reaches the position \textcircled{2}, regardless of a signal from the contact pin, thereby stopping spraying of the washer fluid.

That is, the controller 13 turns off (stops) the washer motor 15 and stops spraying of the washer fluid from the washer nozzle, when a predetermined time (for example, 100 ms) passes after the washer fluid starts to be sprayed.

For example, the controller 13 may stops spraying of washer fluid, when the contact pin reaches the position \textcircled{3} in the first open period.

In certain embodiments, the point of time of starting to spray the washer fluid may be adjusted by adjusting the length of the first closed period P of the position sensing plate 17. For the first closed period P, length tuning is required for the types of vehicles and it is required to select a common length to prevent a change in length.

In certain embodiments, it may be required to tune the point of time of stopping spraying of washer fluid, when there is a large difference in wiping angle of wiper blades for the types of vehicles.

Thereafter, the wiper blade keeps moving, without the washer fluid sprayed, to the upper end (see the position A in FIG. 4) of the windshield glass through the position \textcircled{4}, and then it is moved back towards the lower end from the upper end of the windshield glass by the wiper motor.

Referring to FIG. 4, the wiper blade moves down to the position B of the windshield glass from the upper end, that is, the position A of the windshield glass and the washer motor 15 operates in response to a signal from the controller 13, and accordingly, the washer nozzle sprays washer fluid downward.

The controller 13 recognizes that the wiper blade is positioned at the upper end of the windshield glass on the basis of a signal inputted from the contact pin when the wiper blade is at the position A.

In position A, the contact pin is positioned at the second closed period P′ (or the first closed period P) of the position sensing plate 17 and inputs a signal (contact signal) generated by physically coming in contact with the position sensing plate 17 to the controller 13, and the controller 13 recognizes that the wiper blade is at the upper end of the windshield glass on the basis of the contact signal.

When the wiper blade moves toward the down end of the windshield glass from the upper end, that is, the position A and then reaches the position B and the contact pin starts to physically separate from the position sensing plate 17, coming out of the second closed period P′, the controller 13 recognizes the position (close to the upper end of the glass) of the wiper blade on the basis of a signal from the contact pin at the position B of the position sensing plate 17 and turns on (operates) the washer motor 15, thereby spraying washer fluid.

The wiper blade keeps moving toward the lower end of the windshield glass, and the controller 13 turns off (stops) the washer motor in a predetermined time (set in advance) after the contact pin reaches the position B, regardless of a signal from the contact pin, thereby stopping spraying of the washer fluid.

That is, the controller 13 turns off (stops) the washer motor 15 and stops spraying of the washer fluid from the washer nozzle, when a predetermined time (for example, 100 ms) passes after the washer fluid starts to be sprayed.

For example, the controller 13 may stops spraying of washer fluid, when the contact pin reaches the position C in the second open period.

Thereafter, the wiper blade keeps moving toward the lower end (position \textcircled{1} in FIG. 3) of the windshield glass through the position D, without washer fluid sprayed, and it repeats this process until the wiper motor stops.

In other embodiments, the controller may operate the washer motor to start spraying of washer fluid when the contact pin comes in contact with the position sensing plate and to stop spraying of the washer fluid when the contact pin separates from the position sensing plate.

Embodiments of the invention have been described in detail. However, it will be appreciated by those skilled in the art that changes may be made in these embodiments without departing from the principles and spirit of the invention, the scope of which is defined in the appended claims and their equivalents.

What is claimed is:

1. A system for controlling spraying of washer fluid from a washer nozzle-integrated wiper blade having a wiper motor supplying a driving force for wiping of the wiper blade, the system comprising:
a position sensing plate disposed in the wiper motor and configured to rotate with an output shaft of the wiper motor when the wipe motor operates, the position sensing plate having a plurality of alternating closed periods and open periods;
a contact pin configured to physically come in contact with the position sensing plate in the closed periods and separate from the position sensing plate in the open periods when the wiper motor operates, and transmit signals indicating whether it comes in contact with or separates from the position sensing plate; and
a controller that controls operation of the wiper motor on the basis of the signals transmitted by the contact pin.

2. The system of claim 1, wherein the controller operates the washer motor to start spraying of washer fluid when the contact pin separates from the position sensing plate and to stop spraying of the washer fluid when the contact pin comes in contact with the position sensing plate.

3. The system of claim 1, wherein the position sensing plate has a first closed period and a second closed period with open periods therebetween, and
the controller operates the washer motor to start spraying washer fluid when the contact pin starts to separate from the first closed period of the position sensing plate after being in contact with the first closed period, and the controller controls the washer motor to stop spraying the washer fluid, when the contact pin comes in contact with the second closed period of the position sensing plate.

4. The system of claim 1, wherein the controller operates the washer motor to start spraying of washer fluid when the contact pin separates from the position sensing plate and to stop spraying the washer fluid when a predetermined time passes after the washer fluid starts to be sprayed.

5. The system of claim 1, wherein the position sensing plate has a first closed period and a second closed period with open periods therebetween, and
the controller operates the washer motor to start spraying washer fluid when the contact pin starts to separate from the first closed period of the position sensing plate after being in contact with the first closed period, and the controller controls the washer motor to stop spraying of the washer fluid when a predetermined time passes after the washer fluid starts to be sprayed.

6. The system of claim 5, wherein the predetermined time is 100 ms.

7. The system of claim 1, wherein the position sensing plate includes at least one copper plate.

8. The system of claim 1, wherein the controller operates the washer motor to start spraying of washer fluid when the contact pin comes in contact with the position sensing plate and to stop spraying of the washer fluid when the contact pin separates from the position sensing plate.
